(19) United States
(12) Patent Application Publication
(10) Pub. No.: US 2008/0111912 A1
(43) Pub. Date: May 15, 2008

(54) METHODS AND APPARATUSES FOR GENERATING INFORMATION REGARDING SPATIAL RELATIONSHIP BETWEEN A LENS AND AN IMAGE SENSOR OF A DIGITAL IMAGING APPARATUS AND RELATED ASSEMBLING METHODS

(76) Inventor: Mei-Ju Chen, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/557,976

(22) Filed: Nov. 9, 2006

(51) Int. Cl. H04N 5/235

(52) U.S. Cl. 348/362; 348/335

(57) ABSTRACT

Methods and apparatuses for generating information regarding spatial relationship between a lens and an image sensor of a digital imaging apparatus are provided. One proposed method includes: providing uniform light; driving the image sensor to sense the uniform light via the lens to generate a corresponding image; and generating the information according to the image. Additionally, an inspecting method can be performed to determine if the digital imaging apparatus is defective in accordance with the image.

### BACKGROUND

The present invention relates to digital imaging techniques, and more particularly, to methods and apparatuses for generating information regarding spatial relationship between a lens and an image sensor of a digital imaging apparatus and related assembling and inspecting methods.

For digital imaging apparatuses, such as digital still cameras or digital video cameras, image quality is one of the most significant design issues. In an image generated by an image sensor of a conventional digital imaging apparatus, the central portion of the image is typically brighter than the peripheral portion of the image. This phenomenon is also referred to as lens shading effect, which is caused by a non-uniform light response across the lens of the digital imaging apparatus. In the related art, various lens shading compensation (a.k.a. uniformity correction) methods have been disclosed in order to mitigate the lens shading effect.

In the conventional lens shading compensation methods, two basic assumptions are that the lens is parallel to the image sensor, and the center point of the image sensor is located on an axis vertically passing through the optical center of the lens. Accordingly, the conventional lens shading compensation method performs a spherical intensity correction to correct each pixel value of the image by an amount that is a function of the radius of the pixel from the center point of the image.

Unfortunately, there is usually a misalignment between the lens and the image sensor due to the asymmetry of the lens or the imperfections in the assembling processes. For example, parallel misalignment and angular misalignment are two typical types of misalignment between the lens and the image sensor. Thus, the lens may not be parallel to the image sensor. Similarly, the center point of the image sensor may not be located on the axis vertically passing through the optical center of the lens. As a result, the conventional lens shading compensation method may erroneously compensate the image thereby degrading the image quality.

### SUMMARY

It is therefore an objective of the claimed invention to provide methods and apparatuses for generating information regarding spatial relationship between a lens and an image sensor of a digital imaging apparatus and related assembling and inspecting methods to solve the above-mentioned problems.

An exemplary embodiment of a method for generating information regarding spatial relationship between a lens and an image sensor of a digital imaging apparatus is disclosed. The proposed method comprises: providing uniform light; driving the image sensor to sense the uniform light via the lens to generate a corresponding image; and generating the information according to the image.

An exemplary embodiment of an information generation apparatus for generating information regarding spatial relationship between a lens and an image sensor of a digital imaging apparatus is disclosed. The information generation apparatus comprises: a light source for providing uniform light; and an inspection device for driving the image sensor to sense the uniform light via the lens and generate a corresponding image, and for generating the information according to the image.

An exemplary embodiment of a method for assembling a digital imaging apparatus is disclosed comprising: providing a module having a lens and an image sensor; providing uniform light; driving the image sensor to sense the uniform light via the lens to generate a corresponding image; generating information regarding spatial relationship between the lens and the image sensor of the digital imaging apparatus according to the image; and writing the information into the digital imaging apparatus.

An exemplary embodiment of a method for inspecting a digital imaging apparatus having a lens and an image sensor is disclosed comprising: providing uniform light; driving the image sensor to sense the uniform light via the lens to generate a corresponding image; and determining if the digital imaging apparatus is defective according to the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an information generation apparatus according to an exemplary of the present invention.

FIG. 2 is a flowchart illustrating a method for generating information regarding spatial relationship between a lens and an image sensor of FIG. 1 according to an exemplary embodiment of the present invention.

FIG. 3 is a schematic diagram illustrating an ideal spatial relationship between the lens and the image sensor of FIG. 1.

FIG. 4 is a schematic diagram of the image generated by the image sensor of FIG. 3.

FIG. 5 is a schematic diagram illustrating an example of parallel misalignment between the lens and the image sensor of FIG. 1.

FIG. 6 is a schematic diagram of the image generated by the image sensor of FIG. 5.

FIG. 7 is a schematic diagram illustrating an example of angular misalignment between the lens and the image sensor of FIG. 1.

FIG. 8 is a schematic diagram of the image generated by the image sensor of FIG. 7.

FIG. 9 is a flowchart illustrating a method for assembling the digital imaging apparatus of FIG. 1 according to an exemplary embodiment of the present invention.

FIG. 10 is a flowchart illustrating a method for inspecting the digital imaging apparatus of FIG. 1 according to an exemplary embodiment.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

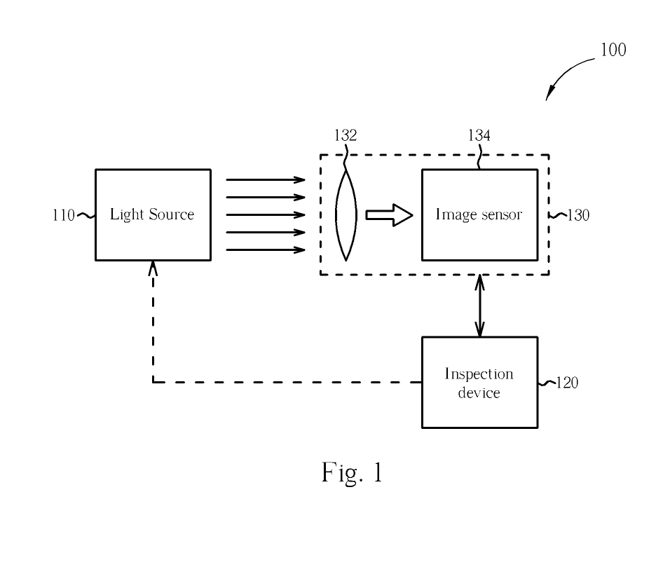

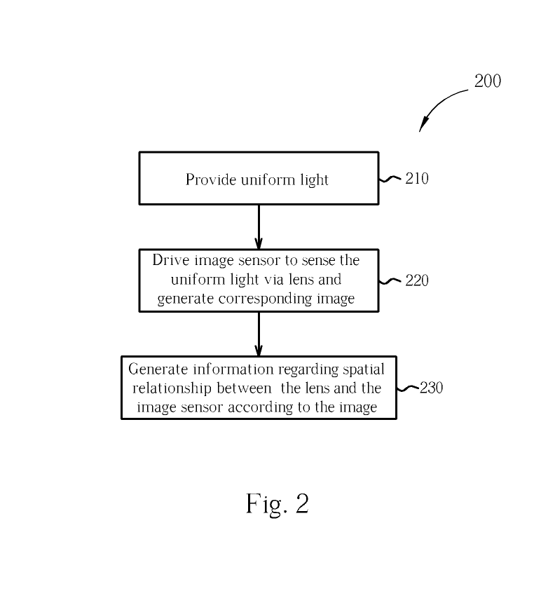

Please refer to FIG. 1, which shows a simplified block diagram of an information generation apparatus 100 according to an exemplary of the present invention. The information generation apparatus 100 is utilized for generating information regarding spatial relationship between a lens 132 and an image sensor 134 of a digital imaging apparatus 130. In practice, the digital imaging apparatus 130 may be a stand-alone device or an optical module for use in the stand-alone device. By way of example, the digital imaging apparatus 130 may be a digital still camera (DSC), a digital video camera (DV), a phone camera, a PC camera, a security camera, a machine vision camera, a microscope camera, a medical imaging apparatus (e.g., a laparoscope/endoscope), etc. Thereto, the digital imaging apparatus 130 may be an optical module for use in the above devices. For example, the digital imaging apparatus 130 may be a compact camera module (CCM) of a camera phone. As illustrated in FIG. 1, the information generation apparatus 100 comprises a light source 110 and an inspection device 120. Hereinafter, operations and implementations of the information generation apparatus 100 will be explained with reference to FIG. 2.

FIG. 2 is a flowchart 200 illustrating a method for generating information regarding spatial relationship between the lens 132 and the image sensor 134 of FIG. 1 according to an exemplary embodiment of the present invention. Steps of the flowchart 200 are described below.

In step 210, the light source 110 of the information generation apparatus 100 provides uniform light to the digital imaging apparatus 130. Specifically, the uniform light is emitted toward the lens 132 of the digital imaging apparatus 130.

In step 220, in practice, the image sensor 134 may be a CCD, a CMOS sensor, or any other component having similar functionalities. The image generated by the image sensor 134 is then transmitted to the inspection device 120. Please note that the image may be a raw image that is directly converted from the light sensed by the image sensor 134 or a single-color image derived from the raw image. The data format of pixel value of the image may vary with the applications of the digital imaging apparatus 130. For example, the pixel value of the image may be represented in RGB domain, YCrCb domain, or other formats.

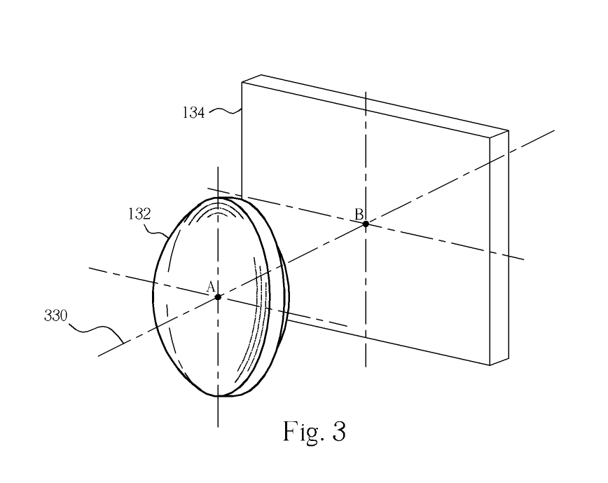

In step 230, the inspection device 120 generates information regarding spatial relationship between the lens 132 and the image sensor 134 according to the image generated by the image sensor 134. As described previously, there may be a misalignment between the lens 132 and the image sensor 134. Accordingly, the actual spatial relationship between the lens 132 and the image sensor 134 needs to be identified so that the lens shading compensation for the image sensor 134 can be performed correctly. In this embodiment, the inspection device 120 examines the pixel values of image to determine the spatial relationship between the lens 132 and the image sensor 134, and to accordingly generate information for use in the lens shading compensation operation of the image sensor 134. The operations of the inspection device 120 in step 230 will be described in detail with reference to FIG. 3 through FIG. 8.

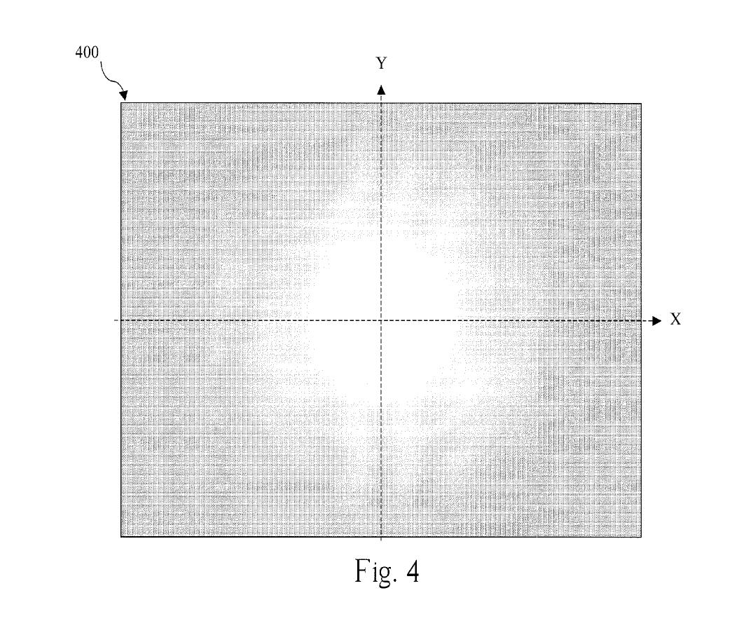

FIG. 3 depicts a schematic diagram illustrating an ideal spatial relationship between the lens 132 and the image sensor 134 of the digital imaging apparatus 130. In an ideal scheme, the thickness of the lens 132 is symmetrical with respect to the center point A of the lens 132, so the center point A is also the optical center of the lens 132. Accordingly, when the lens 132 is accurately aligned to the image sensor 134, the lens 132 is parallel to the image sensor 134, and the center point B of the image sensor 134 is located on an axis 330 that vertically passes through the optical center A of the lens 132. As a result, the image generated by the image sensor 134 in step 220 is similar to an image 400 illustrated in FIG. 4. As shown in FIG. 4, the central portion of the image 400 is brighter than the peripheral portion of the image 400 and the brightness distribution pattern of the image 400 approximates to a round shape.

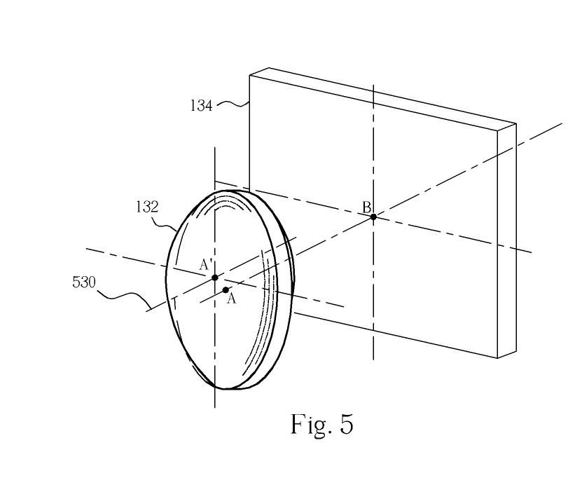

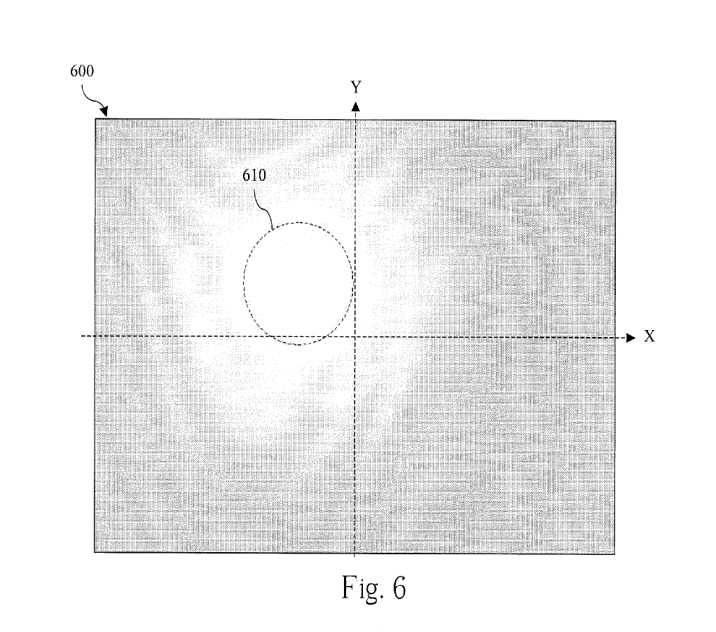

Please refer to FIG. 5, which illustrates an example of parallel misalignment between the lens 132 and the image sensor 134. The parallel misalignment between the lens 132 and the image sensor 134 is typically caused by the asymmetry of the lens 132, i.e., the thickness of the lens 132 is not symmetrical with respect to the center point A of the lens 132. In the scheme illustrated in FIG. 5, the lens 132 is parallel to the image sensor 134 but the center point A of the lens 132 differs from the optical center A′ of the lens 132. Therefore, the center point B of the sensor image 134 is not located on an axis 530 vertically passing through the optical center A′ of the lens 132. As a result, the image generated by the image sensor 134 in step 220 is similar to an image 600 illustrated in FIG. 6. As shown in FIG. 6, the brightness distribution pattern of the image 600 approximates to a round shape, but the brightest portion of the image 600 diverges from the central portion of the image 600.

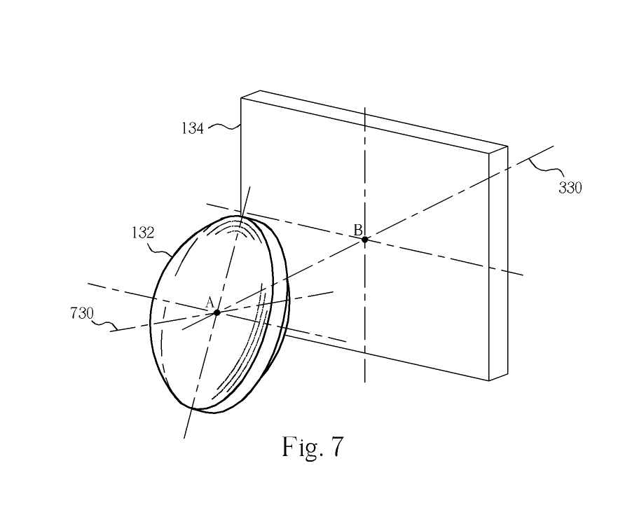

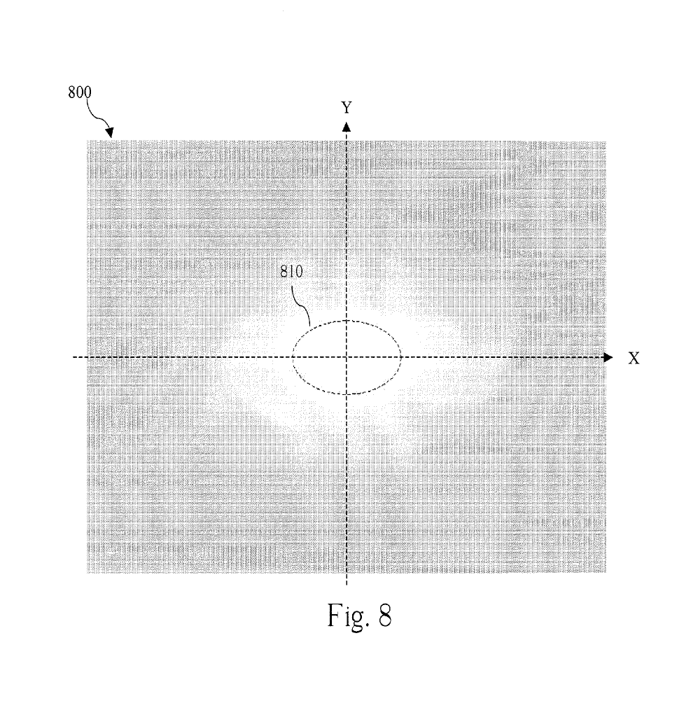

FIG. 7 depicts an example of angular misalignment between the lens 132 and the image sensor 134. The angular misalignment is typically caused by the process deviation of the digital imaging apparatus 130 or other imperfections in the assembling processes, such as that the lens 132 is not accurately paralleled the image sensor 134. In such a scheme, the center point B of the sensor image 134 is not located on an axis 730 vertically passing through the optical center A of the lens 132. Accordingly, the brightness distribution pattern of the image generated by the image sensor 134 in step 220 approximates to an elliptic shape as well as an image 800 illustrated in FIG. 8. In practice, the parallel misalignment and the angular misalignment may occur concurrently. Typically, such a hybrid misalignment causes the image generated by the image sensor 134 to have a brightness distribution pattern that is a hybrid from the examples shown in FIG. 6 and FIG. 8.

As can be inferred from the foregoing descriptions, the spatial relationship between the lens 132 and the image sensor 134 influences the pattern of the image generated by the image sensor 134. Accordingly, the inspection device 120 can determine the spatial relationship between the lens 132 and the image sensor 134 according to the image generated by the image sensor 134. In one embodiment, the inspection device 120 calculates a barycentric coordinate of the image according to pixel values of the image and outputs the barycentric coordinate as the information in step 230. In one aspect, the barycentric coordinate of the image substantially corresponds to the position of projection of the optical center of the lens 132 on the image sensor 134.

In practical implementations, the inspection device 120 can further determine if any pixel of the image has a pixel value greater than a predetermined threshold before performing step 230. Preferably, the predetermined threshold is set to be a value that approximates or equals to a maximum allowable pixel value supported by the image sensor 134 or the digital imaging apparatus 130. If the image is determined to have at least one pixel whose pixel value is greater than the predetermined threshold, the inspection device 120 of this embodiment performs an adjusting procedure so that no pixel of the image has a pixel value reaching the predetermined threshold. In the adjusting procedure, the inspection device 120 may control the light source 110 to adjust the luminance of the uniform light so as to lower the average pixel value of the image generated by the image sensor 134. Alternatively, the inspection device 120 can adjust a diaphragm or a shutter of the digital imaging apparatus 130 to reduce the light received by the image sensor 134, thereby lowering the average pixel value of the image. Note that the above adjusting approaches can be adopted concurrently to adjust the pixel value of the image.

In another embodiment, the inspection device 120 identifies a target region of the image, and then generates the information according to pixel values of the target region in step 230, wherein each pixel value within the target region reaches a predetermined value. In practice, the predetermined value may be a fixed value or a variable. For example, suppose that the maximum pixel value of the image 600 shown in FIG. 6 is 255, the inspection device 120 may select a region 610 formed by pixels with each having a pixel value greater than 200 as a target region. In another example, the inspection device 120 identifies a maximum pixel value of the image, and then divides the maximum pixel value by a predetermined factor to generate the predetermined value.

When the target region of the image is identified, the inspection device 120 generates the information according to pixel values of the target region. For example, the inspection device 120 may calculate a barycentric coordinate of the target region according to pixel values of the target region as the information in step 230. In another embodiment, the inspection device 120 calculates a coordinate of the geometric center of the target region as the information in step 230. Similar to the barycentric coordinate of the image, the barycentric coordinate of the target region or the coordinate of the geometric center of the target region typically corresponds the position of projection of the optical center of the lens 132 on the image sensor 134. Accordingly, the calculated coordinate can be employed as a parameter for a lens shading compensation operation, so that the lens shading compensation operation can perform a spherical intensity correction to correct each pixel value of the image by an amount that is a function of the radius of the pixel from the calculated coordinate. In another aspect, the inspection device 120 can determine if there is a parallel misalignment between the lens 132 and the image sensor 134 according to the calculated coordinate.

As in the foregoing descriptions, the brightness distribution pattern of the image generated by the image sensor 134 approximates to an elliptic shape as illustrated in FIG. 8 if there is an angular misalignment between the lens 132 and the image sensor 134. Therefore, the inspection device 120 can determine a pixel value distribution pattern of the image, and generate the information according to the determined brightness distribution in step 230. In practice, the inspection device 120 can take the barycentric coordinate of the image as a base point, and calculate a plurality of pixel value gradients with respect to the base point to determine the pixel value distribution pattern of the image. Alternatively, the inspection device 120 can identify a target region of the image (e.g., a target region 810 of the image 800) as well as the disclosed embodiments and determine the pixel value distribution pattern of the image according to the shape of the target region. In accordance with the determined pixel value distribution pattern of the image, the inspection device 120 can determine if there is an angular misalignment between the lens 132 and the image sensor 134 and generate corresponding information for use in the lens shading compensation operation, such as a degree of the angular misalignment between the lens 132 and the image sensor 134. Specifically, if the shape of the target region approximates to an ellipsoid, the inspection device 120 determines that there is an angular misalignment between the lens 132 and the image sensor 134. On the contrary, if the shape of the target region approximates to a circle, the inspection device 120 determines that there is no angular misalignment between the lens 132 and the image sensor 134. As a result, the correctness and performance of the lens shading compensation operation can be significantly improved.

In practice, the lens shading compensation operation may use the same information (e.g., the same barycentric coordinate) to compensate respective pixel value domains of the image. Alternatively, the lens shading compensation operation may compensate each pixel value domain of the image according to corresponding information of the pixel value domain. Accordingly, the inspection device 120 may calculate a plurality of barycentric coordinates corresponding to a plurality of pixel value domains of the image and generate the information according to the plurality of barycentric coordinates. Thereto, inspection device 120 may identify a plurality of target regions corresponding to a plurality of pixel value domains of the image and generate the information according to pixel values of the plurality of target regions.

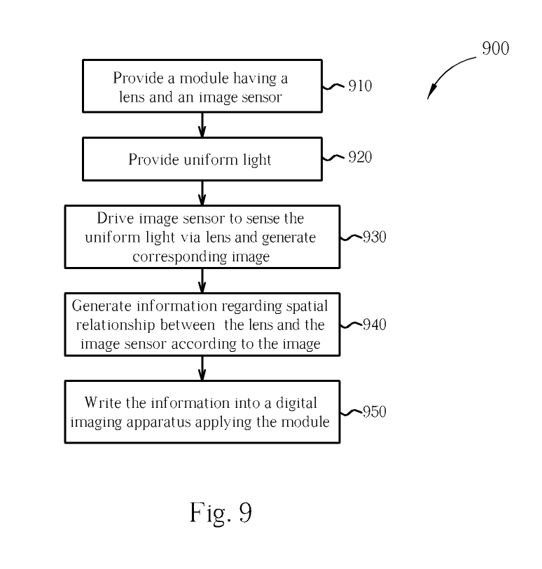

In addition, the disclosed information generation apparatus 100 can be applied in the assembling process of a digital imaging apparatus. For example, FIG. 9 is a flowchart 900 illustrating a method for assembling the digital imaging apparatus 130 according to an exemplary embodiment of the present invention. Steps of the flowchart 900 are described in following paragraphs.

In step 910, a module having the lens 132 and the image sensor 134 is provided.

In step 920, the light source 110 of the information generation apparatus 100 provides uniform light to the digital imaging apparatus 130.

In step 930, the inspection device 120 then drives the image sensor 134 to sense the uniform light from the light source 110 via the lens 132 and to generate a corresponding image.

In step 940, the inspection device 120 generates information regarding spatial relationship between the lens 132 and the image sensor 134 according to the image generated by the image sensor 134 in step 930. The operations of steps 920 through 940 are substantially the same as the aforementioned steps 210 through 230, respectively. Accordingly, repeated descriptions are therefore omitted herein for the sake of brevity.

When the information regarding the spatial relationship between the lens 132 and the image sensor 134 is generated, the inspection device 120 performs step 950 to write the information into the digital imaging apparatus 130. For example, the inspection device 120 may write the information into a register, a buffer, a memory, or other storage unit of the digital imaging apparatus 130 for later use. As described above, the information stored in the digital imaging apparatus 130 can be used as parameters of the lens shading compensation operation to improve the performance of the lens shading compensation operation.

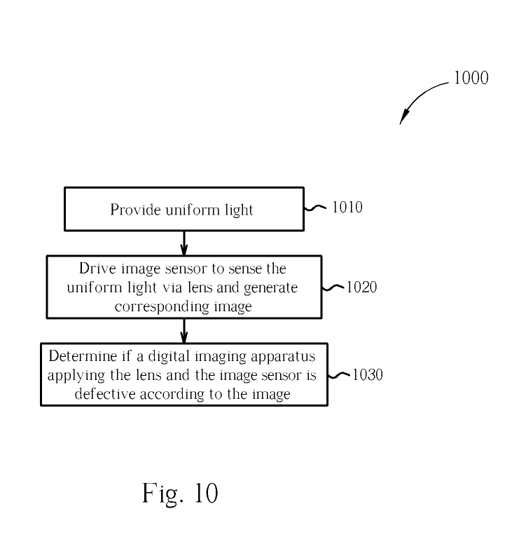

In another aspect of the present invention, the disclosed information generation apparatus 100 can also be utilized in the quality control process of a digital imaging apparatus. For example, FIG. 10 is a flowchart 1000 illustrating a method for inspecting the digital imaging apparatus 130 according to an exemplary embodiment. Steps of the flowchart 1000 are described thereinafter.

In step 1010, the light source 110 of the information generation apparatus 100 provides uniform light to the digital imaging apparatus 130.

In step 1020, the inspection device 120 drives the image sensor 134 to sense the uniform light from the light source 110 via the lens 132 and to generate a corresponding image. The operations of steps 1010 and 1020 are substantially the same as the aforementioned steps 210 and 220, respectively. Therefore, further details are omitted herein for the sake of brevity.

In step 1030, the inspection device 120 determines if the digital imaging apparatus 130 is defective according to the image generated by the image sensor 134. As in the foregoing descriptions, the inspection device 120 can generate information regarding the spatial relationship between the lens 132 and the image sensor 134 according to the image. In accordance with the information, the inspection device 120 can further determine whether the digital imaging apparatus 130 is defective. For example, the inspection device 120 can derive a distance between the center point of the image sensor 134 and the projection of the optical center of the lens 132 on the image sensor 134 from the barycentric coordinate of the image, and then compare the distance with a predetermined distance to determine if the digital imaging apparatus 130 is defective. In one embodiment, the inspection device 120 determines that the digital imaging apparatus 130 is defective if the distance between the center point of the image sensor 134 and the projection of the optical center of the lens 132 on the image sensor 134 exceeds the predetermined distance.

Similarly, the inspection device 120 can derive a degree of the angular misalignment between the lens 132 and the image sensor 134 from the shape of the pixel value distribution pattern of the image, and determine if the digital imaging apparatus 130 is defective according to the degree. In one embodiment, the inspection device 120 determines that the digital imaging apparatus 130 is defective if the degree is greater than a certain value.

Please note that all combinations and sub-combinations of the above-described features also belong to the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating information regarding spatial relationship between a lens and an image sensor of a digital imaging apparatus, the method comprising:
providing uniform light;
driving the image sensor to sense the uniform light via the lens and generate a corresponding image; and
generating the information according to the image.

2. The method of claim 1, wherein the information is for use in a lens shading compensation operation of the image sensor.

3. The method of claim 1, further comprising:
determining if any pixel of the image has a pixel value greater than a predetermined threshold; and
if the image is determined to have at least one pixel whose pixel value is greater than the predetermined threshold, performing an adjusting procedure so that no pixel of the image has a pixel value greater than the predetermined threshold.

4. The method of claim 3, wherein the predetermined threshold approximates to a maximum allowable pixel value supported by the image sensor.

5. The method of claim 3, wherein the adjusting procedure comprises:
adjusting the luminance of the uniform light.

6. The method of claim 3, wherein the adjusting procedure comprises:
adjusting a diaphragm of the digital imaging apparatus.

7. The method of claim 3, wherein the adjusting procedure comprises:
adjusting a shutter of the digital imaging apparatus.

8. The method of claim 1, wherein the step of generating the information comprises:
identifying a target region of the image in which the target region is formed by pixels, each of which has a pixel value reaching a predetermined value; and
generating the information according to pixel values of the target region.

9. The method of claim 8, wherein the step of generating the information according to pixel values of the target region comprises:
calculating a coordinate of a geometric center of the target region as the information.

10. The method of claim 8, wherein the step of generating the information according to pixel values of the target region comprises:
calculating a barycentric coordinate of the target region as the information.

11. The method of claim 8, further comprising:
identifying a maximum pixel value of the image; and
calculating the predetermined value according to the maximum pixel value.

12. The method of claim 1, wherein the step of generating the information comprises:
calculating a barycentric coordinate of the image according to pixel values of the image as the information.

13. The method of claim 1, wherein the step of generating the information comprises:
determining a pixel value distribution pattern of the image; and
generating the information according to the determined brightness distribution.

14. The method of claim 13, wherein the step of determining the pixel value distribution pattern of the image comprises:
identifying a target region of the image in which the target region is formed by pixels, each of which has a pixel value reaching a predetermined value; and
determining the pixel value distribution pattern according to the shape of the target region.

15. The method of claim 1, wherein the step of generating the information comprises:
calculating a barycentric coordinate of the image according to pixel values of the image;
determining a pixel value distribution pattern of the image; and
generating the information according to the barycentric coordinate of the image and the determined pixel value distribution pattern.

16. The method of claim 1, wherein the step of generating the information comprises:
identifying a target region of the image in which the target region is formed by pixels, each of which has a pixel value reaching a predetermined value;
determining a pixel value distribution pattern of the image; and
generating the information according to pixel values of the target region and the determined pixel value distribution pattern.

17. The method of claim 1, wherein the step of generating the information comprises:
calculating a plurality of barycentric coordinates corresponding to a plurality of pixel value domains of the image; and
generating the information according to the plurality of barycentric coordinates.

18. The method of claim 1, wherein the step of generating the information comprises:
identifying a plurality of target regions corresponding to a plurality of pixel value domains of the image, wherein each target region is formed by pixels, each of which has a pixel value reaching a corresponding predetermined value; and
generating the information according to pixel values of the plurality of target regions.

19. An information generation apparatus for generating information regarding spatial relationship between a lens and an image sensor of a digital imaging apparatus, the information generation apparatus comprising:
a light source for providing uniform light; and
an inspection device for driving the image sensor to sense the uniform light via the lens and generate a corresponding image, and for generating the information according to the image.

20. The information generation apparatus of claim 19, wherein the information is for use in a lens shading compensation operation of the image sensor.

21. The information generation apparatus of claim 19, wherein the inspection device further determines if any pixel of the image has a pixel value greater than a predetermined threshold, and if the image is determined to have at least one pixel whose pixel value is greater than the predetermined threshold, the inspection device performs an adjusting procedure so that no pixel of the image has a pixel value greater than the predetermined threshold.

22. The information generation apparatus of claim 21, wherein the predetermined threshold approximates to a maximum allowable pixel value supported by the image sensor.

23. The information generation apparatus of claim 21, wherein the inspection device controls the light source to adjust the luminance of the uniform light in the adjusting procedure.

24. The information generation apparatus of claim 21, wherein the inspection device adjusts a diaphragm of the digital imaging apparatus in the adjusting procedure.

25. The information generation apparatus of claim 21, wherein the inspection device adjusts a shutter of the digital imaging apparatus in the adjusting procedure.

26. The information generation apparatus of claim 19, wherein the inspection device identifies a target region of the image in which the target region is formed by pixels, each of which has a pixel value reaching a predetermined value, and generates the information according to pixel values of the target region.

27. The information generation apparatus of claim 26, wherein the inspection device calculates a coordinate of a geometric center of the target region as the information.

28. The information generation apparatus of claim 26, wherein the inspection device calculates a barycentric coordinate of the target region as the information.

29. The information generation apparatus of claim 26, wherein the inspection device identifies a maximum pixel value of the image, and calculates the predetermined value according to the maximum pixel value.

30. The information generation apparatus of claim 19, wherein the inspection device calculates a barycentric coordinate of the image according to pixel values of the image as the information.

31. The information generation apparatus of claim 19, wherein the inspection device determines a pixel value distribution pattern of the image, and generates the information according to the determined brightness distribution.

32. The information generation apparatus of claim 31, wherein the inspection device identifies a target region of the image in which the target region is formed by pixels, each of which has a pixel value reaching a predetermined value, and determines the pixel value distribution pattern according to the shape of the target region.

33. The information generation apparatus of claim 19, wherein the inspection device calculates a barycentric coordinate of the image according to pixel values of the image, determines a pixel value distribution pattern of the image, and generates the information according to the barycentric coordinate of the image and the determined pixel value distribution pattern.

34. The information generation apparatus of claim 19, wherein the inspection device identifies a target region of the image in which the target region is formed by pixels, each of which has a pixel value reaching a predetermined value, determines a pixel value distribution pattern of the image, and generates the information according to pixel values of the target region and the determined pixel value distribution pattern.

35. The information generation apparatus of claim 19, wherein the inspection device calculates a plurality of barycentric coordinates corresponding to a plurality of pixel value domains of the image, and generates the information according to the plurality of barycentric coordinates.

36. The information generation apparatus of claim 19, wherein the inspection device identifies a plurality of target regions corresponding to a plurality of pixel value domains of the image in which each target region is formed by pixels, each of which has a pixel value reaching a corresponding predetermined value, and generates the information according to pixel values of the plurality of target regions.

37. A method for assembling a digital imaging apparatus, comprising:
providing a module having a lens and an image sensor;
providing uniform light;
driving the image sensor to sense the uniform light via the lens and generate a corresponding image;
generating information regarding spatial relationship between the lens and the image sensor of the digital imaging apparatus according to the image; and
writing the information into the digital imaging apparatus.

38. The method of claim 37, wherein the information is for use in a lens shading compensation operation of the image sensor.

39. The method of claim 37, further comprising:
determining if any pixel of the image has a pixel value greater than a predetermined threshold; and
if the image is determined to have at least one pixel whose pixel value is greater than the predetermined threshold, performing an adjusting procedure so that no pixel of the image has a pixel value greater than the predetermined threshold.

40. The method of claim 39, wherein the predetermined threshold approximates to a maximum allowable pixel value supported by the digital imaging apparatus.

41. The method of claim 39, wherein the adjusting procedure comprises:
adjusting the luminance of the uniform light.

42. The method of claim 39, wherein the adjusting procedure comprises:
adjusting a diaphragm of the digital imaging apparatus.

43. The method of claim 39, wherein the adjusting procedure comprises:
adjusting a shutter of the digital imaging apparatus.

44. The method of claim 37, wherein the step of generating the information comprises:
identifying a target region of the image in which the target region is formed by pixels, each of which has a pixel value reaching a predetermined value; and
generating the information according to pixel values of the target region.

45. The method of claim 44, wherein the step of generating the information according to pixel values of the target region comprises:
calculating a coordinate of a geometric center of the target region as the information.

46. The method of claim 44, wherein the step of generating the information according to pixel values of the target region comprises:
calculating a barycentric coordinate of the target region as the information.

47. The method of claim 44, further comprising:
identifying a maximum pixel value of the image; and
calculating the predetermined value according to the maximum pixel value.

48. The method of claim 37, wherein the step of generating the information comprises:
calculating a barycentric coordinate of the image according to pixel values of the image as the information.

49. The method of claim 37, wherein the step of generating the information comprises:
determining a pixel value distribution pattern of the image; and
generating the information according to the determined brightness distribution.

50. The method of claim 49, wherein the step of determining the pixel value distribution pattern of the image comprises:
identifying a target region of the image in which the target region is formed by pixels, each of which has a pixel value reaching a predetermined value; and
determining the pixel value distribution pattern according to the shape of the target region.

51. The method of claim 37, wherein the step of generating the information comprises:
calculating a barycentric coordinate of the image according to pixel values of the image;
determining a pixel value distribution pattern of the image; and
generating the information according to the barycentric coordinate of the image and the determined pixel value distribution pattern.

52. The method of claim 37, wherein the step of generating the information comprises:
identifying a target region of the image in which the target region is formed by pixels, each of which has a pixel value reaching a predetermined value;
determining a pixel value distribution pattern of the image; and
generating the information according to pixel values of the target region and the determined pixel value distribution pattern.

53. The method of claim 37, wherein the step of generating the information comprises:
calculating a plurality of barycentric coordinates corresponding to a plurality of pixel value domains of the image; and
generating the information according to the plurality of barycentric coordinates.

54. The method of claim 37, wherein the step of generating the information comprises:
identifying a plurality of target regions corresponding to a plurality of pixel value domains of the image, wherein each target region is formed by pixels, each of which has a pixel value reaching a corresponding predetermined value; and
generating the information according to pixel values of the plurality of target regions.

55. A method for inspecting a digital imaging apparatus having a lens and an image sensor, the method comprising:
providing uniform light;
driving the image sensor to sense the uniform light via the lens and to generate a corresponding image; and
determining if the digital imaging apparatus is defective according to the image.

56. The method of claim 55, wherein the step of determining if the digital imaging apparatus is defective comprises:
generating information regarding spatial relationship between the lens and the image sensor according to the image; and
determining whether the digital imaging apparatus is defective according to the information.

57. The method of claim 56, wherein the information corresponds to the misalignment between the lens and the image sensor.

58. The method of claim 56, wherein the step of generating the information comprises:
identifying a target region of the image in which the target region is formed by pixels, each of which has a pixel value reaching a predetermined value; and
generating the information according to pixel values of the target region.

59. The method of claim 58, wherein the step of generating the information according to pixel values of the target region comprises:
calculating a coordinate of a geometric center of the target region as the information.

60. The method of claim 58, wherein the step of generating the information according to pixel values of the target region comprises:
calculating a barycentric coordinate of the target region as the information.

61. The method of claim 58, further comprising:
identifying a maximum pixel value of the image; and
calculating the predetermined value according to the maximum pixel value.

62. The method of claim 56, wherein the step of generating the information comprises:
calculating a barycentric coordinate of the image according to pixel values of the image as the information.

63. The method of claim 56, wherein the step of generating the information comprises:
determining a pixel value distribution pattern of the image; and
generating the information according to the determined brightness distribution.

64. The method of claim 63, wherein the step of determining the pixel value distribution pattern of the image comprises:
identifying a target region of the image in which the target region is formed by pixels, each of which has a pixel value reaching a predetermined value; and
determining the pixel value distribution pattern according to the shape of the target region.

65. The method of claim 56, wherein the step of generating the information comprises:
calculating a barycentric coordinate of the image according to pixel values of the image;
determining a pixel value distribution pattern of the image; and
generating the information according to the barycentric coordinate of the image and the determined pixel value distribution pattern.

66. The method of claim 56, wherein the step of generating the information comprises:
identifying a target region of the image in which the target region is formed by pixels, each of which has a pixel value reaching a predetermined value;
determining a pixel value distribution pattern of the image; and
generating the information according to pixel values of the target region and the determined pixel value distribution pattern.

67. The method of claim 56, wherein the step of generating the information comprises:
calculating a plurality of barycentric coordinates corresponding to a plurality of pixel value domains of the image; and
generating the information according to the plurality of barycentric coordinates.

68. The method of claim 56,wherein the step of generating the information comprises:
identifying a plurality of target regions corresponding to a plurality of pixel value domains of the image, wherein each target region is formed by pixels, each of which has a pixel value reaching a corresponding predetermined value; and
generating the information according to pixel values of the plurality of target regions.

69. The method of claim 55, further comprising:
determining if any pixel of the image has a pixel value greater than a predetermined threshold; and
if the image is determined to have at least one pixel whose pixel value is greater than the predetermined threshold, performing an adjusting procedure so that no pixel of the image has a pixel value greater than the predetermined threshold.

70. The method of claim 69, wherein the predetermined threshold approximates to a maximum allowable pixel value supported by the image sensor.

71. The method of claim 69, wherein the adjusting procedure comprises:
adjusting the luminance of the uniform light.

72. The method of claim 69, wherein the adjusting procedure comprises:
adjusting a diaphragm of the digital imaging apparatus.

73. The method of claim 69, wherein the adjusting procedure comprises: adjusting a shutter of the digital imaging apparatus.
